(19) United States
(12) Patent Application Publication
(10) Pub. No.: US 2020/0116105 A1
(43) Pub. Date: Apr. 16, 2020

(54) COMMON BULKHEAD FOR A PRESSURE VESSEL

(71) Applicant: ROXEL FRANCE, SAINT-MEDARD-EN-JALLES (FR)

(72) Inventor: Didier ZANELLI, SAINT-MEDARD-EN-JALLES (FR)

(21) Appl. No.: 16/598,994

(22) Filed: Oct. 10, 2019

(30) Foreign Application Priority Data
Oct. 12, 2018 (FR) 1859505

(51) Int. Cl. F02K 9/38; F02K 9/28; F02K 9/34

(52) U.S. Cl. CPC F02K 9/38; F02K 9/343; F02K 9/28

(57) ABSTRACT

The invention lies in the field the management of pressures and relates to a common bulkhead for a pressure vessel having two chambers, the common bulkhead being intended to be positioned between a first chamber and a second chamber of the pressure vessel and configured to withstand a first predetermined pressure in the first chamber and to allow a fluid from the second chamber to flow above a second predetermined pressure, wherein it comprises: a metallic basic structure comprising a first face intended to be positioned facing towards the first chamber, a second face intended to be positioned facing towards the second chamber, a plurality of through-openings between the first face and the second face having a polygonal-type pattern in section, an external frame at its periphery, a first metallic cap superposed on the first face covering the plurality of through-openings.

### CROSS-REFERENCE TO RELATED APPLICATIONS

This application claims priority to foreign French patent application No. FR 1859505, filed on Oct. 12, 2018, the disclosure of which is incorporated by reference in its entirety.

### FIELD OF THE INVENTION

The present invention lies in the field of the management of pressures. It relates to a common bulkhead for a pressure vessel having two chambers. The invention also relates to a thruster equipped with such a common bulkhead.

In the field of propulsion, the ongoing pursuit of a greater range has led to the development of solid propulsion systems referred to as double-pulse propulsion systems, as shown schematically in FIG. 1. This type of system 5 has two propellant charges 24, 25, two ignition devices 26, 27 and a single assembly 19 of one or more nozzles via which the expansion of the combustion gases originating from the combustion of the propellant charges takes place, in order to create optimal thrust.

### BACKGROUND

In operation, a first thrust is brought about by initiation of the first solid propellant charge by the first ignition device. During this phase, the gases released are accelerated by the nozzle assembly, like in a conventional single-pulse thruster. It is necessary to protect the second propellant charge from the combustion gases of the first charge, lest it ignite. To provide this protection, a common bulkhead 6 is interposed between the two propellant charges 24, 25. This common bulkhead should withstand the pressure of the gases generated by the first propellant charge with a sufficient margin. Typically, if the maximum operating pressure of the first charge is 15 MPa, the maximum withstand pressure of the common bulkhead should be 15 MPa plus a safety coefficient of around 1.5, i.e. 22.5 MPa. This strength should take into account the heating that arises during the operation of the first propellant charge.

Next, a second thrust is brought about by the initiation of the second solid propellant charge by the second ignition device. The common bulkhead opens. The gases then flow through the common bulkhead and then into the combustion chamber of the first charge, which is now empty, before reaching the nozzle assembly, where the gases are accelerated and converted into thrust.

The common bulkhead has multiple roles: in addition to protecting the second propellant charge during the ignition and combustion of the first charge, it has to open under a low pressure of the second charge in order to minimize the impact upon ignition and to afford a flow cross section for the gases output by the second charge that is as large as possible in order to minimize the erosion of the common bulkhead and of the thermal protection of the first combustion chamber during the phase of homogenizing the resultant flow and to minimize the drop in pressure between the two chambers.

Solutions exist for separating the charges of double-pulse propulsion systems. In particular, the peelable or non-peelable flexible walls may be cited. These solutions have drawbacks. The flexible walls have to be fastened to the structure of the system either by adhesive bonding or by a bulky mechanical system. It is often not possible to test the leaktightness of the wall. The durability of the adhesive bond that is critical for the propulsion function may be a difficulty.

The flexible wall technology generally necessitates a simple charge geometry, which is fairly hard to reconcile with the requirement of a thrust profile that is as constant as possible.

The charging process when a flexible wall is employed is complex. The charges are cast successively, the first being cured twice, the first of which may only be partial. During casting and curing, the flexible wall is subject to significant mechanical and chemical attack.

Moreover, it is absolutely necessary that the flexible wall be chemically compatible with the two propellants of the two charges. The plasticizers contained in the formulations of the propellants might have a negative effect on the durability of the adhesive bonds of the flexible wall.

Finally, in the case of a peelable flexible wall, in order to provide the full performance of a double-pulse thruster, it is necessary to ensure that the entire wall peels after several decades of aging.

There also exist, for example, rigid common bulkheads that have circular perforations for allowing the gases originating from the combustion of the second charge to pass through. Such a prior-art common bulkhead 6 is shown schematically in FIG. 2. The rigid common bulkheads of the prior art are not optimal since they have a redundant surface that counters the flow of gases output by the second charge. This results in local recirculation zones and zones with a high speed concentration, which are not desired. Similarly, the flow cross section for the gases between the two chambers is limited.

### SUMMARY OF THE INVENTION

The invention aims to remedy all or some of the problems cited above by proposing a rigid common bulkhead that is easy to incorporate into a double-pulse thruster, without necessitating geometric constraints on the charges, allowing a simplified charging process, without any problems of chemical compatibility with the propellant charges. The rigid common bulkhead according to the invention also allows a reduction in its mass, in its volume, while increasing the flow cross section for the gases.

To this end, the subject of the invention is a common bulkhead for a pressure vessel having two chambers, the common bulkhead being intended to be positioned between a first chamber and a second chamber of the pressure vessel and configured to withstand a first predetermined pressure in the first chamber and to allow a fluid from the second chamber to flow above a second predetermined pressure. According to the invention, the common bulkhead comprises:
a basic structure comprising a first face intended to be positioned facing towards the first chamber, a second face intended to be positioned facing towards the second chamber, a plurality of through-openings between the first face and the second face having a polygonal-type pattern in section, a first metallic cap superposed on the first face covering the plurality of through-openings.

Advantageously, a section with a polygonal-type pattern has an edge substantially parallel to an edge of a section with a polygonal-type pattern that is adjacent thereto.

According to one embodiment, at least one of the plurality of through-openings comprises a means for reducing the stress concentrations at at least one intersection of two edges of the section, preferably a chamfer or a fillet.

According to another embodiment, at least one of the plurality of through-openings comprises a means for making flow entry easier at the intersection between said through-opening and the second face, preferably a fillet or a chamfer.

The basic structure may be made of ceramic or metallic.

Advantageously, the first face and/or second face and/or lateral faces of at least one of the plurality of through-openings in the metallic basic structure are covered at least partially by a thermal protection.

According to another embodiment, the common bulkhead comprises an external frame at its periphery, the external frame comprises an external face extending on the opposite side from the basic structure and two internal faces intended to be in contact with the first and the second chamber, respectively, and the common bulkhead comprises at least one duct extending between the external face and one of the chambers.

According to another embodiment, the common bulkhead comprises at least one second metallic cap superposed on the first face and on the first cap.

According to another embodiment, the common bulkhead also comprises at least one flexibility element positioned between the first cap and the second cap and/or between two adjacent caps.

According to another embodiment, the basic structure comprises a central through-opening between the first face and the second face and an internal frame delimiting the central opening.

The invention relates to the embodiment of a common bulkhead, the pressure vessel having two chambers being a double-pulse thruster, the double-pulse thruster comprising:
the first chamber being a first combustion chamber intended to receive a first propellant charge and the second chamber being a second combustion chamber intended to receive a second propellant charge,
a first ignition device intended to ignite the first propellant charge,
a second ignition device intended to ignite the second propellant charge,
a nozzle assembly made up of one or more nozzles via which the expansion of combustion gases originating from the first and/or second propellant charge following ignition of the first and/or second propellant charge takes place, the common bulkhead being configured to withstand the first predetermined pressure in the first combustion chamber brought about by the combustion gases originating from the first propellant charge following ignition of the first propellant charge and to allow the fluid formed by the combustion gases originating from the second propellant charge following ignition of the second propellant charge to flow.

The invention also relates to a thruster comprising at least two combustion chambers, each being intended to receive a propellant charge, and comprising at least one common bulkhead as described in the present application, positioned between the two combustion chambers.

### BRIEF DESCRIPTION OF THE DRAWINGS

The invention will be understood better and further advantages will become apparent from reading the detailed description of an embodiment given by way of example, said description being illustrated by the appended drawing, in which:

FIG. 1 schematically shows a known double-pulse propulsion system;

FIG. 2 schematically shows a common bulkhead according to the prior art;

FIG. 3 schematically shows an embodiment of a common bulkhead according to the invention;

FIG. 4 schematically shows another embodiment of a common bulkhead according to the invention;

FIG. 5 schematically shows a variant section of the through-openings in the common bulkhead according to the invention;

FIG. 6 schematically shows examples of sections of through-openings in the common bulkhead according to the invention;

FIG. 7 schematically shows another embodiment of a common bulkhead according to the invention;

FIG. 8 schematically shows another view of a common bulkhead according to the invention;

FIG. 9 schematically shows another embodiment of a common bulkhead for carrying out leaktightness and/or hermeticity tests according to the invention;

FIG. 10 schematically shows a cross-sectional view of another embodiment of a common bulkhead with increased safety according to the invention;

FIG. 11 schematically shows a double-pulse thruster according to the invention.

For the sake of clarity, the same elements will bear the same reference signs in the various figures. For a better view and for the sake of greater understanding, the elements are not always shown to scale.

### DETAILED DESCRIPTION

The invention is described in the field of solid propulsion, in relation to a double-pulse thruster. Clearly, the thruster may be a thruster with more than two pulses, with more than two propellant charges and with as many common bulkheads as there are combustion chambers to be separated. Moreover, the invention applies to any other field requiring the management of pressures. In particular, the common bulkhead according to the invention withstands a high-pressure in one direction of stress (from the first chamber 11 to the second chamber 12) and allows a flow of fluid (liquid or gas) to escape in the other direction of stress (from the second chamber 12 to the first chamber 11) as soon as the associated pressure exceeds a low threshold level, typically with a pressure ratio of between 5:1 and 20:1.

Thus, besides the double-pulse thruster, the invention can find application as a diode base or safety element on containers that are intended to withstand high external pressures and release the internal pressure as soon as it goes up, or vice versa. The cylindrical outer shape is not absolutely necessary, it is suitable for the propulsion of tactical missiles (external aerodynamics). For other applications, it could have any other section, for example one that is square, triangular, etc.

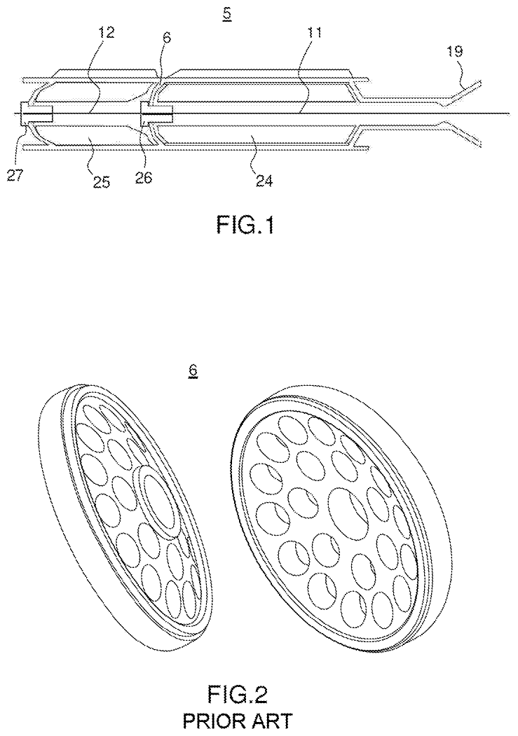

FIG. 1 schematically shows a known double-pulse propulsion system 5 that has already been presented in the introduction.

FIG. 2 schematically shows a common bulkhead 6 according to the prior art and was discussed in the introduction.

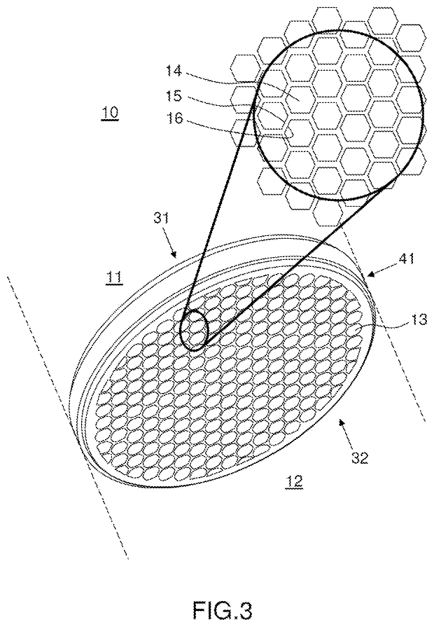

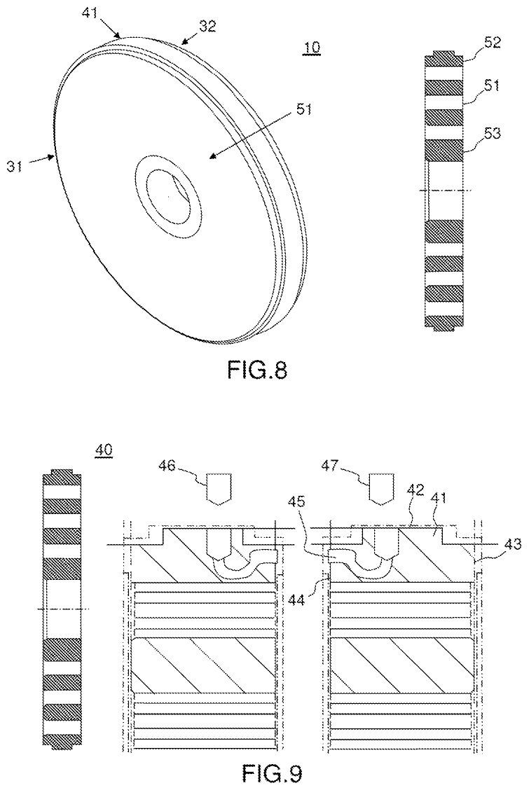

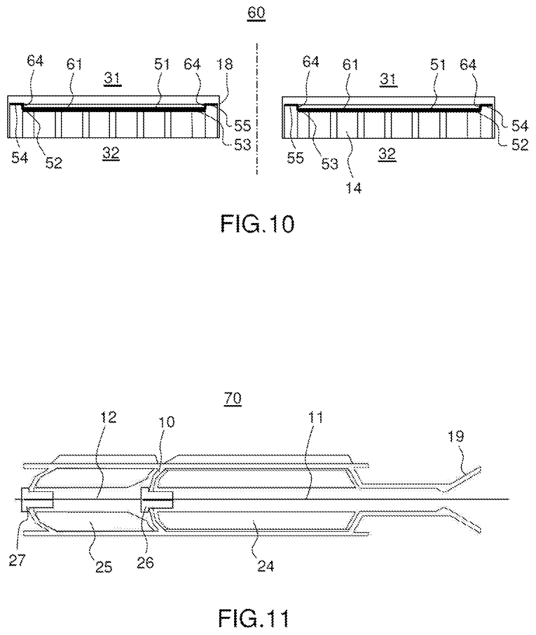

FIG. 3 schematically shows an embodiment of a common bulkhead 10 according to the invention. The common bulkhead 10 shown in FIG. 3 is intended to equip a pressure vessel having two chambers 11, 12. It is intended to be positioned between a first chamber 11 and a second chamber 12 of the pressure vessel, and configured to withstand a first predetermined pressure in the first chamber 11 and to allow a fluid (gas or liquid, the nonlimiting example of gas is used here) originating from the second chamber 12 to flow above a second predetermined pressure (more precisely beyond a predetermined pressure variation between the second chamber and the first chamber. In order to make it easier to understand, pressure in the second chamber is spoken of here, even if it is in fact more specifically a predetermined pressure variation, as explained above, between the second chamber and the first chamber). According to the invention, the common bulkhead 10 comprises a basic structure 13 comprising a first base 31 intended to be positioned facing towards the first chamber 11, a second face 32 intended to be positioned facing towards the second chamber 12, a plurality of through-openings 14 between the first face 31 and the second chamber 12 (meaning that the openings 14 pass through between the first chamber and the second chamber) having a polygonal-type pattern in section. The common bulkhead 10 according to the invention also comprises a first metallic cap 51 (not shown in FIG. 3, but shown more specifically in FIG. 8) superposed on the first face 31 covering the plurality of through-openings 14. The common bulkhead 10 may comprise an external frame 41 at its periphery. The first metallic cap 51 may be fastened to the basic structure 13 at the external frame 41 by a first fastening means 52 (not shown, but shown in FIGS. 8 and 10), or it can be fastened to the structure of the first combustion chamber. The first fastening means 52 may be a weld bead or any other suitable fastening means such as a screw or a rivet which can ensure both mechanical integrity and leaktightness.

In other words, the basic structure 13 comprises a plurality of perforations which have a section in the form of a polygon, in other words a closed broken line.

As explained above, the first charge 24, once ignited, produces a first thrust that corresponds to the first pressure predetermined by the type of propellant charge in question. During this phase, the gases released are accelerated by the nozzle assembly 19. The common bulkhead 10 protects the second propellant charge 25 from the combustion gases of the first charge 24. The metallic cap 51 ensures leaktightness. It is for example welded to the rings of the external frame 41 by a weld bead 52 in order to ensure the leaktightness with regard to the combustion gases output by the first propellant charge 24 and integrity with respect to the pressure forces of the first charge (around 25 MPa). Typically, the thickness of the cap is from 0.05 to 0.2 mm depending on the steel that is used, which preferably needs to be weldable to the rings. Preferably, a steel with a very high deformation outbreak is used to make the cap 51. Advantageously, but not absolutely necessary, use is made of X2CrNi18-09(T651) if the external frame 41 is made of Maraging 300 (stainless steel reinforced with cobalt with addition of 18% nickel). The cap 51 deforms while withstanding the force and ensuring leaktightness with respect to the pressure of the combustion gases from the first chamber 11.

After a period calculated depending on the mission to be carried out (generally from a few seconds to a few tens of seconds), the second charge 25 is ignited. The common bulkhead opens under a pressure that this time comes from the second chamber 12. The expression uncapping is used. Typically, a pressure known as the uncapping pressure for the common bulkhead of around 4 MPa is chosen. The gases then flow through the common bulkhead 10, through the plurality of through-openings 14, and then into the first chamber 1, which is empty, in order to reach the nozzle assembly 19.

Thus, the common bulkhead 10 according to the invention opens under a low pressure originating from the second chamber 12, in order to minimize the impact upon ignition. The uncapping pressure (that is to say the pressure for opening the cap) of the common bulkhead is chosen to be compatible with ignition in accordance with standard practice. The common bulkhead also affords a passage cross section for the gases originating from the second charge that is as large as possible.

Specifically, advantageously, a section with a polygonal-type pattern has an edge 15 substantially parallel to an edge 16 of a section with a polygonal-type pattern adjacent thereto (see the local zoom of the through-openings 14 above FIG. 3). In other words, the sections interlock with one another and leave little space between two adjacent perforations. This results in a useful surface area for a maximum flow. Despite this, the mechanical strength of the common bulkhead 10 thus obtained is extremely high. The stresses in the structure are well distributed.

The common bulkhead 10 is optimized in terms of its manufacture. While the production of a bulk head from structural steel by a conventional machining process is difficult, if not impossible, the production by additive manufacturing by melting powder, laser fusion or by electron beam is quite suitable. Re-machining operations are minimal, thereby contributing towards minimizing the overall cost of producing the common bulkhead. Similarly, the thickness of the common bulkhead is minimal on account of the high rigidity and high strength of the geometry, minimizing the space requirement of the common bulkhead.

The invention is based on the repeating pattern having a polygon in section. The section may have a triangular, square, rectangular, pentagonal, hexagonal or octagonal shape or any other polygonal shape or any other combination of polygonal shapes. It should be noted that some sections are preferably, for example hexagonal sections. In the case of pentagonal or octagonal sections, the patterns interlock less optimally with one another, leaving space between the through-openings. Therefore, it is advantageous to position between two spaced-apart openings, an opening with a different section (diamond or the like) and/or with a section of smaller size. Around the perimeter of the structure (outside, and inside if necessary), it is possible for the openings to be incomplete and not then to form a polygonal section. These cells can nonetheless be maintained or, if they have a section that is too small, they can be eliminated.

This results in great rigidity and resistance to bending brought about by the operating pressure of the first propellant charge 24. For example with a hexagonal pattern as shown in FIG. 3, the basic structure 13 resembles a honeycomb, which is flexurally rigid, lightweight and compact. The passage cross section for the flow of the gases produced by the second charge 25 that is afforded by the juxtaposition of the cells (or perforations, through-openings 14) is at a maximum.

It may be noted that, in the case of the common bulkhead 10 shown in FIG. 3, the ignition device 26 for the first charge 24 is not located on the common bulkhead 10 but is remote, for example in a rear assembly of the thruster. This is one variant, but another variant is conceivable, as explained above.

Finally, on the common bulkhead shown in FIG. 3, it is possible to see fillets and chamfers. It should be specified that the fillets and the chamfers are not absolutely necessary, but one or the other, or both, may be present, as explained below.

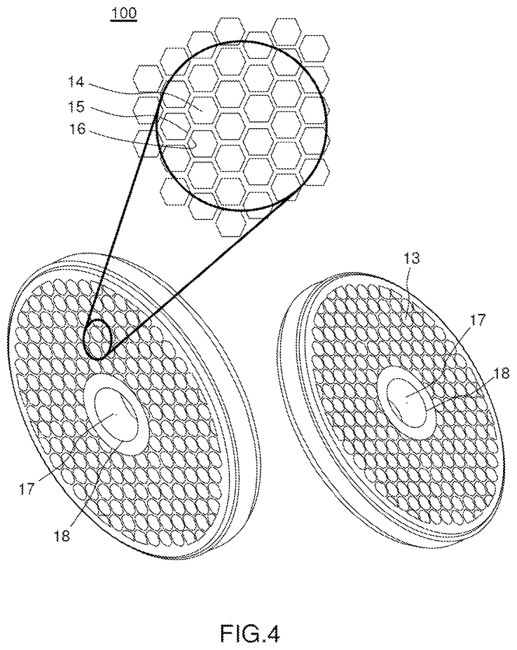

FIG. 4 schematically shows another embodiment of a common bulkhead 100 according to the invention. The basic structure 13 of the common bulkhead 100 shown in FIG. 4 is identical to that of the common bulkhead 10 shown in FIG. 3. The common bulkhead 100 also comprises a central through-opening 17 between the first chamber 11 and the second chamber 12 and an internal frame 18 delimiting the central opening 17. The central through-opening 17 is intended to receive the first ignition device 26 and the internal frame 18 is intended to form a support for the first ignition device 26.

With or without a central opening 17, owing to the through-openings 14, the passage cross section for the gases is twice the size compared with a prior-art common bulkhead as shown in FIG. 2 (more than four times the neck section) and the mass is reduced (by around 30%). The height (that is to say the thickness of the bulkhead) is also less than that of a prior-art bulkhead. The flow through the common bulkhead according to the invention is as homogeneous as possible, and overspeeds and recirculations of the gases are minimal.

The cap assembly is less stressed by the first propellant charge 24 on account of the smaller size of the polygonal perforations 14 compared with the large circular perforations in a prior-art common bulkhead. Thinner caps can be used, making it possible to all the better meet the requirement of uncapping at low pressure under the effect of the second propellant charge 25.

FIG. 5 schematically shows a variant section of the through-openings 14 in a common bulkhead 20 according to the invention. The common bulkhead 20, only shown in part in FIG. 5 (only a portion of the basic structure is shown), is identical to the common bulkheads 10 and 100 presented above. It differs from the common bulkheads 10, 100 in that at least one of the plurality of through-openings 14 comprises a means for reducing stress concentrations, for example a fillet 21 at at least one intersection of two consecutive edges 22, 23 of the section. In other words, one or more perforations 14 may have a fillet at an intersection of two consecutive edges of the section, or at two intersections, or all the intersections. The fillet is not necessarily present at the intersection of each of the intersections of consecutive edges. Preferably, all the through-openings 14 have a fillet at all the intersections of the consecutive edges. The presence of a fillet minimizes the stresses between the nodes (or connections) between the through-openings 14. In the scope of the invention, it is possible to replace the fillets with chamfers or any other geometry for attenuating the local stress spikes at the connections or nodes. At least one of the plurality of through-openings can thus comprise a chamfer or a fillet (or another other shape for improving the inlet of the flow through the structure) at the intersection between said through-opening and the second face.

Finally, on the common bulkhead shown in FIG. 5, it is possible to see chamfers. It should be specified that the chamfers are not absolutely necessary, but can be present, as explained below.

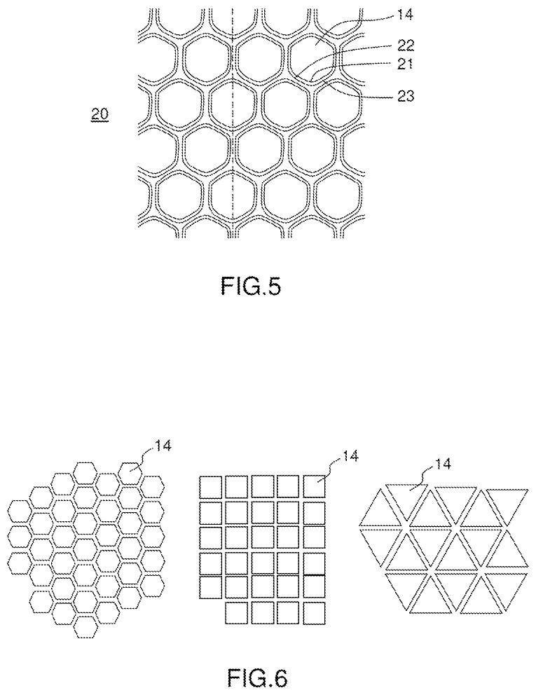

FIG. 6 schematically shows examples of the section of the through-openings 14 in the common bulkhead according to the invention. As discussed above, the section can have any closed broken line shape: triangular, rectangular, diamond-shaped, hexagonal, octagonal, etc. Advantageously, the sections are juxtaposed so as to interlock with one another, with very thin connections between the through-openings 14.

It should be noted that, advantageously, the pattern is repetitive. However, the invention also covers the possibility of an alternation of several patterns, for example triangular on one part of the basic structure and hexagonal on another part.

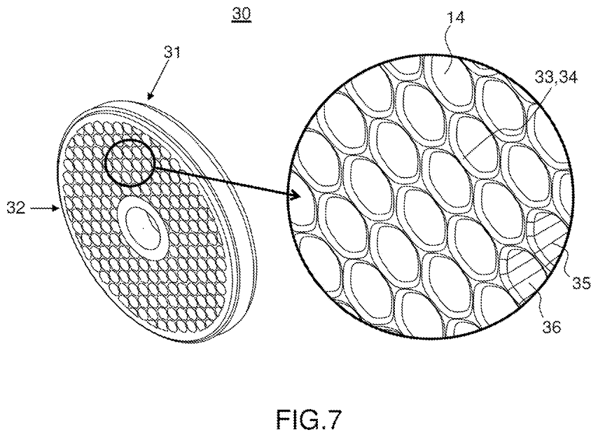

FIG. 7 schematically shows another embodiment of a common bulkhead 30 according to the invention. The basic structure 13 of the common bulkhead 30 comprises a first face 31 intended to be positioned facing the first chamber 11 and a second face 32 intended to be positioned facing the second chamber 12. At least one of the plurality of through-openings 14 comprises a means for making the inlet of the flow easier, for example a chamfer 33 or a fillet 34 (or any other shape for improving the inlet of the flow through the structure) at the intersection between said through-opening 14 and the second face 32. This feature makes it easier for the gases originating from the combustion of the second propellant charge to flow through the common bulkhead 30 between the second chamber 12 and the first chamber 11.

The basic structure may be made of ceramic, for example C-SiC. Since ceramic is not weldable, some other means for fastening the cap(s) than the weld beam has to be considered. Since the mechanical strength of ceramics is not as high as that of steels, the geometry of the basic structure should be adapted. The advantage of a basic structure made of ceramic is that it does not require additional thermal protection.

Alternatively, the basic structure may be metallic.

In another variant, the first face 31 and/or second face 32 and/or lateral faces 35 of at least one of the plurality of through-openings 14 are covered at least partially with a thermal protection 36, in order to protect these parts from the ablation of the flow of combustion gases originating from the second propellant charge. The thermal protection may be a ceramic. Alternatively, it may be thermal protection made of a low-elongation monoplast, a composite made up of around 70% of fibres or powder or both, carbon, glass or silica or Kevlar or a mixture thereof, and around 30% of a thermosetting resin, for example phenolic or cyanate ester or epoxy resin. This resin breaks down under the effect of heat, leaving a significant carbon residue, making it possible to partially evacuate the thermal energy of the gases and to maintain the reinforcement. The thermal protection made of a low-elongation monoplast requires an increase in the thickness of the protection compared with the thickness of a ceramic. Alternatively, a flexible thermal protection can be used, with yet a further increase in the thickness of the protection. The flexible thermal protection is a composite made up of around 40% of fibres or powder or both, carbon, glass, silica or Kevlar or a mixture thereof, and around 60% of a silicone, EPDM (abbreviation of ethylene propylene diene monomer), or polychloroprene.

It may be specified that if the combustion time of the second charge is short or if the ablation of the metallic structure of the common bulkhead is tolerated, no thermal protection is used.

An example of a metallic structure of the common bulkhead is a stainless steel with structural hardening of the type M300, M250, 17-4 PH, 15-5 PH, X12, chromium steel, an alloy of aluminum, of iconel, of titanium, etc.

FIG. 8 schematically shows the common bulkhead 10 according to the invention on the side of the first face 31. Visible therein are the external frame 41 at its periphery, and the first metallic cap 51 superposed on the first face 31 covering the plurality of through-openings 14 and fastened to the basic structure 13 at the external frame 41 by a first fastening means 52 (for example a weld bead, screw, rivet). The flat metallic cap 51 ensures the leaktightness, as explained above.

In the case in which the common bulkhead comprises a through-opening 17 between the first chamber 11 and the second chamber 12 and an internal frame 18 delimiting the central opening 17, the cap 51 is also fastened to the basic structure 13 at the internal frame 18 by a third fastening means 53, for example a weld bead, screw, rivet. Alternatively, the cap(s) can be fastened to the structure of the first combustion chamber.

FIG. 9 schematically shows another embodiment of a common bulkhead 40 for carrying out leaktightness and/or hermeticity tests according to the invention. The external frame 41 comprises an external face 42 extending on the opposite side from the basic structure 13 and two internal faces 43, 44 intended to be in contact with the first and the second chamber 11, 12, respectively, and the common bulkhead 40 comprises at least one duct 45 extending between the external face 42 and one of the chambers 11, 12. This type of duct is easy to produce by additive manufacturing. It makes it possible to connect the outside of the double-pulse propulsion system to one or both combustion chambers and makes it possible to carry out leaktightness or hermeticity tests. Its geometry overcomes all the conventional machining constraints and the duct can take on a profile that is as complex as imaginable in order to fit in the available space. Once the tests have been carried out at the end of the process of integrating the thruster, the duct(s) is/are closed off by any means 46, 47 for closure, leaktightness, perfect hermeticity of the duct(s) (and thus of the combustion chamber(s)), for example a conical screw.

FIG. 10 schematically shows a cross-sectional view of another embodiment of a common bulkhead 60 with increased safety according to the invention. The common bulkhead according to the invention may comprise at least one second metallic cap 61 superposed on the first face 31 and on the first cap 51. Just like the first cap, it may be fastened to the basic structure 13 at the external frame 41 or be fastened to the structure of the first combustion chamber by a second fastening means 54, for example a weld bead or any other suitable fastening means such as a screw or a rivet. The use of the second cap 61 increases the margin of safety of the cap 51, which may sometimes be critical from a safety point of view. This second cap 61 is preferably flat and of the same thickness as the first cap 51, but slightly larger in diameter in order to superpose the first cap 51. The second cap 61 is for its part also welded to the external frame 41 or to the structure of the first chamber by additional weld beads. Thus, the critical function of the cap is fully doubled, thus decreasing its criticality. Under the load created by the first propellant charge, the resistance of the system of caps with its two caps 51, 61 is double. The two caps 51, 61 are redundant. On the same principle, a third cap may cover the second cap, which may itself be covered by a fourth cap etc.

The common bulkhead may also comprise at least one flexibility element 64 positioned between the first cap 51 and the second cap 61 (and/or between two adjacent caps in the case of more than two caps), making it possible to decouple the uncapping of the two caps 51 and 61 of the system of caps. The flexibility element is advantageously positioned at the peripheries of the caps, preferably at the fastening means. Thus, the fastening means 52 and 53 of the first cap 51 are stressed without any contribution of the cap 61 and its fastening means 54 and 55, and it is the flexibility element 64 that is stressed. Thus, the resistance of the system of caps to the pressure of the first propellant charge 24 is doubled while the uncapping pressure remains the same. In other words, when the common bulkhead is subjected to a pressure originating from the second chamber, it is the first cap 51 that is subjected to this pressure first. The flexibility element 64, for its part, acts as a buffer between the two caps, such that the second cap 61 is not stressed by the pressure originating from the second chamber as long as the first cap 51 is present and intact. The first cap 51 opens at a predetermined pressure (for example 4 MPa). Once open, the second cap 61 is then, only from this moment, exposed to the pressure originating from the second chamber (4 MPa in this example). If the second cap 61 has a thickness and fastening means that are identical to that/those of the first cap 51, it opens likewise at the same predetermined pressure. The two caps 51 and 61 are indeed redundant in this operation and ensure greater safety: the resistance to the pressure originating from the first chamber is double, and despite this, the two caps 51, 61 open at a predetermined pressure, which may be lower, originating from the second chamber. The flexibility elements may be placed between two adjacent caps, depending on the number of caps present.

FIG. 11 schematically shows a double-pulse thruster 70 according to the invention. The thruster 70 comprises at least two combustion chambers 11, 12, each being intended to receive a propellant charge 24, 25. The thruster 70 comprises at least one common bulkhead as described above, which is positioned between the two combustion chambers 11, 12.

The invention is also applicable to any pressure vessel comprising more than two juxtaposed chambers, for example three chambers with common bulkheads therebetween, or more than three chambers.

Since the thruster 70 comprises at least two combustion chambers 11, 12, it can thus be a multiple-pulse thruster.

1. A Common bulkhead for a pressure vessel having two chambers, the common bulkhead being intended to be positioned between a first chamber and a second chamber of the pressure vessel and configured to withstand a first predetermined pressure in the first chamber and to allow a fluid from the second chamber to flow above a second predetermined pressure, comprising:
a basic structure comprising a first face intended to be positioned facing towards the first chamber, a second face intended to be positioned facing towards the second chamber, a plurality of through-openings between the first face and the second face,
a first metallic cap superposed on the first face covering the plurality of through-openings,
wherein the plurality of through-openings have a polygonal section.

2. The common bulkhead according to claim 1, wherein a polygonal section has an edge substantially parallel to an edge of a polygonal section adjacent thereto.

3. The common bulkhead according to claim 1, wherein at least one of the plurality of through-openings comprises a means for reducing the stress concentrations at at least one intersection of two edges of the section, preferably a fillet or a chamfer.

4. The common bulkhead according to claim 1, wherein at least one of the plurality of through-openings comprises a means for making flow entry easier at the intersection between said through-opening and the second face, preferably a chamfer or a fillet.

5. The common bulkhead according to claim 1, wherein the basic structure is made of ceramic.

6. The common bulkhead according to claim 1, wherein the basic structure is metallic.

7. The common bulkhead according to claim 6, wherein the first face and/or second face and/or lateral faces of at least one of the plurality of through-openings are covered at least partially by a thermal protection.

8. The common bulkhead according to claim 1, wherein it comprises an external frame at its periphery, in that the external frame comprises an external face extending on the opposite side from the basic structure and two internal faces intended to be in contact with the first and the second chamber, respectively, and in that the common bulkhead comprises at least one duct extending between the external face and one of the chambers.

9. The common bulkhead according to claim 1, wherein the common bulkhead comprises at least one second metallic cap superposed on the first face and on the first cap.

10. The common bulkhead according to claim 9, wherein it also comprises at least one flexibility element positioned between the first cap and the second cap and/or between two adjacent caps.

11. The common bulkhead according to claim 1, wherein the basic structure comprises a central through-opening between the first face and the second face and an internal frame delimiting the central opening.

12. The common bulkhead according to claim 1, wherein the pressure vessel having two chambers is a double-pulse thruster, the double-pulse thruster comprising:
the first chamber being a first combustion chamber intended to receive a first propellant charge and the second chamber being a second combustion chamber intended to receive a second propellant charge,
a first ignition device intended to ignite the first propellant charge,
a second ignition device intended to ignite the second propellant charge,
a nozzle assembly made up of one or more nozzles via which the expansion of combustion gases originating from the first and/or second propellant charge following ignition of the first and/or second propellant charge takes place, the common bulkhead being configured to withstand the first predetermined pressure in the first combustion chamber brought about by the combustion gases originating from the first propellant charge following ignition of the first propellant charge and to allow the fluid formed by the combustion gases originating from the second propellant charge following ignition of the second propellant charge to flow.

13. A thruster comprising at least two combustion chambers, each being intended to receive a propellant charge, wherein it comprises at least one common bulkhead according to claim 12, positioned between the two combustion chambers.
